(19) United States
(12) Patent Application Publication
(10) Pub. No.: US 2014/0300803 A1
(43) Pub. Date: Oct. 9, 2014

(54) IMAGE-CAPTURING SYSTEM

(71) Applicant: LUSTROUS ELECTRO-OPTIC CO., LTD., New Taipei City (TW)

(72) Inventors: CHIH-WEI TSAI, HSINCHU CITY (TW); CHUNG-TA WU, TAIPEI CITY (TW)

(73) Assignee: LUSTROUS ELECTRO-OPTIC CO., LTD., New Taipei City (TW)

(21) Appl. No.: 13/858,163

(22) Filed: Apr. 8, 2013

(51) Int. Cl. G02B 15/16

(52) U.S. Cl. CPC G02B 15/16
USPC 348/360

(57) ABSTRACT

An image-capturing system for automatically adjusting divergence angle includes an image-capturing unit, an auxiliary lighting unit and a control unit. The image-capturing unit includes an image sensor and a zoom lens adjacent to the image sensor. The image sensor is applied to capture images of at least one body through the zoom lens, and the zoom lens has a first variable focus. The auxiliary lighting unit includes at least one light-emitting element for generating light beams and at least one electrically-controlled zoom lens module adjacent to the light-emitting element, and the electrically-controlled zoom lens module has a second variable focus. The light beams generated by the light-emitting element can pass through the electrically-controlled zoom lens module to form a projection light source that can be projected onto the body. The control unit includes a voltage controlling module electrically connected between the image-capturing module and the auxiliary lighting device.

### BACKGROUND OF THE INVENTION

1. Field of the Invention

The instant disclosure relates to an image-capturing system, and more particularly to an image-capturing system having the ability to adjust the divergence angle.

2. Description of Related Art

For enhancing image capture in darker environments, many video cameras utilize light sources generated by lighting devices, emitting light devices, or infrared emitting diodes etc. However, the infrared emitting diodes are often operated by simply being turned on or off. In addition, turning on the infrared emitting diodes when some ambient light is present can generate an excessive level of brightness. When the infrared emitting diodes are turned off altogether when ambient light is not adequate, insufficient brightness remains. Hence, the video camera of the prior art is used without precise adjustment of the infrared emitting diodes, thus image capture is negatively affected.

### SUMMARY OF THE INVENTION

One aspect of the instant disclosure relates to an image-capturing system having the ability to adjust the divergence angle.

One of the embodiments of the instant disclosure provides an image-capturing system having the ability to adjust the divergence angle, comprising: an image-capturing unit, an auxiliary lighting unit and a control unit. The image-capturing unit includes at least one image-capturing module, wherein the at least one image-capturing module includes an image sensor and a zoom lens adjacent and corresponding to the image sensor, the image sensor is used to capture images of at least one body through the zoom lens, and the zoom lens has a first variable focus. The auxiliary lighting unit includes at least one auxiliary lighting device, wherein the at least one auxiliary lighting device includes at least one light-emitting element for generating light beams and at least one electrically-controlled zoom lens module adjacent and corresponding to the at least one light-emitting element, the light beams generated by the at least one light-emitting element pass through the at least one electrically-controlled zoom lens module to form a projection light source that is projected onto the at least one body, and the at least one electrically-controlled zoom lens module has a second variable focus. The control unit includes a voltage controlling module electrically connected between the at least one image-capturing module and the at least one auxiliary lighting device.

Another one of the embodiments of the instant disclosure provides an image-capturing system having the ability to adjust the divergence angle, comprising: an image-capturing unit, an auxiliary lighting unit and a control unit. The image-capturing unit includes at least one image-capturing module, wherein the at least one image-capturing module includes an image sensor and a zoom lens adjacent and corresponding to the image sensor, the image sensor is used to capture images of at least one body through the zoom lens, and the zoom lens has a first variable focus. The auxiliary lighting unit includes at least one auxiliary lighting device, wherein the at least one auxiliary lighting device includes at least one light-emitting element for generating light beams, at least one electrically-controlled zoom lens module, and at least one condensing lens disposed between the at least one light-emitting element and the at least one electrically-controlled zoom lens module, the light beams generated by the at least one light-emitting element sequentially pass through the at least one condensing lens and the at least one electrically-controlled zoom lens module to form a projection light source that is projected onto the at least one body, and the at least one electrically-controlled zoom lens module has a second variable focus. The control unit includes a voltage controlling module electrically connected between the at least one image-capturing module and the at least one auxiliary lighting device.

Yet another one of the embodiments of the instant disclosure provides an image-capturing system having the ability to adjust the divergence angle, comprising: an image-capturing unit, an auxiliary lighting unit and a control unit. The image-capturing unit includes at least one image-capturing module, wherein the at least one image-capturing module includes an image sensor and a zoom lens adjacent and corresponding to the image sensor, the image sensor is used to capture images of at least one body through the zoom lens, and the zoom lens has a first variable focus. The auxiliary lighting unit includes at least one auxiliary lighting device, wherein the at least one auxiliary lighting device includes at least one light-emitting element for generating light beams, at least one condensing lens, and at least one electrically-controlled zoom lens module disposed between the at least one light-emitting element and the at least one condensing lens, the light beams generated by the at least one light-emitting element sequentially pass through the at least one electrically-controlled zoom lens module and the at least one condensing lens to form a projection light source that is projected onto the at least one body, and the at least one electrically-controlled zoom lens module has a second variable focus. The control unit includes a voltage controlling module electrically connected between the at least one image-capturing module and the at least one auxiliary lighting device.

More precisely, the first variable focus of the zoom lens is adjusted according to a variable object distance between the at least one body and the at least one image-capturing module, and the voltage controlling module provides a predetermined voltage value for the at least one electrically-controlled zoom lens module according to the adjustment of the first variable focus of the zoom lens, wherein the second variable focus of the at least one electrically-controlled zoom lens module is adjusted according the predetermined voltage value that is provided by the voltage controlling module, and the divergence angle of the projection light source is adjusted according to the adjustment of the second variable focus of the at least one electrically-controlled zoom lens module.

More precisely, the image-capturing system further comprises a casing unit including an external casing for concurrently receiving the image-capturing unit, the auxiliary lighting unit and the control unit. In addition, the at least one light-emitting element is a light-emitting diode or a laser diode for generating an infrared source, the at least one electrically-controlled zoom lens module is a liquid lens having a variable lens curvature, and the variable lens curvature of the liquid lens is adjusted according to the predetermined voltage value that is provided by the voltage controlling module.

Therefore, because the divergence angle of the projection light source can be adjusted according to the adjustment of the second variable focus of the at least one electrically-controlled zoom lens module, no matter how the variable object distance between the at least one body and the at least one image-capturing module is adjusted or changed, the light beams generated by the at least one light-emitting element can pass through the at least one electrically-controlled zoom lens module to form a projection light source that can be accurately projected onto the at least one body for illuminating the at least one body. Hence, the over or under exposure (i.e., too bright or too dark) of the images does not occur in the instant disclosure, thus the definition and the quality of the images of the at least one body captured by the image-capturing system of the instant disclosure can be increased.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a schematic view of the image-capturing system for capturing the image of the body that is disposed apart from the image-capturing system by a variable object distance D1 according to the first embodiment of the instant disclosure;

FIG. 2 shows a schematic view of the image-capturing system for capturing the image of the body that is disposed apart from the image-capturing system by a variable object distance D2 according to the first embodiment of the instant disclosure;

FIG. 3 shows a schematic view of the image-capturing system for generating a projection light source projecting onto the at least one body that is disposed apart from the image-capturing system by a variable object distance D1 according to the first embodiment of the instant disclosure;

FIG. 4 shows a schematic view of the image-capturing system for generating a projection light source projecting onto the at least one body that is disposed apart from the image-capturing system by a variable object distance D2 according to the first embodiment of the instant disclosure;

FIG. 5 shows a schematic view of the image-capturing system for generating a projection light source projecting onto the at least one body that is disposed apart from the image-capturing system by a variable object distance D1 according to the second embodiment of the instant disclosure; and

FIG. 6 shows a schematic view of the image-capturing system for generating a projection light source projecting onto the at least one body that is disposed apart from the image-capturing system by a variable object distance D2 according to the second embodiment of the instant disclosure.

### DETAILED DESCRIPTION OF THE PREFERRED EMBODIMENTS

### First Embodiment

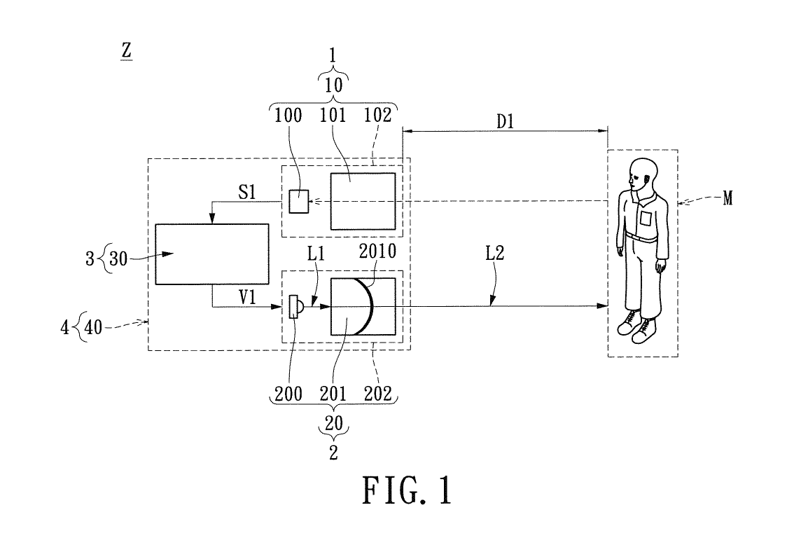

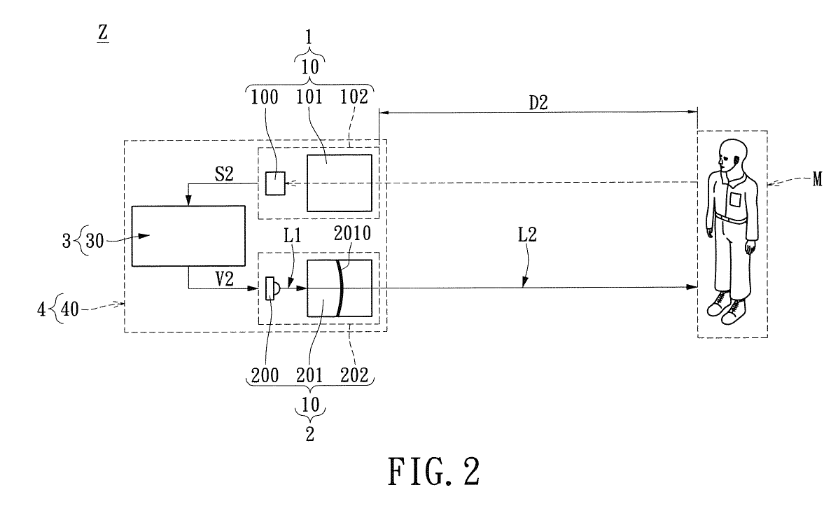

Referring to FIG. 1 and FIG. 2, where the first embodiment of the instant disclosure provides an image-capturing system Z having the ability to adjust the divergence angle, comprising: an image-capturing unit 1, an auxiliary lighting unit 2, a control unit 3 and a casing unit 4.

First, the image-capturing unit 1 includes at least one image-capturing module 10, and the image-capturing module 10 includes an image sensor 100, a zoom lens 101 adjacent and corresponding to the image sensor 100, and a first external casing 102 for concurrently receiving the image sensor 100 and the zoom lens 101. In addition, the image sensor 100 can be used to capture images of at least one body M (such as any movable object) through the zoom lens 101, and the zoom lens 101 has a first variable focus. For example, the image-capturing module 10 may be a video camera having an image surveillance function. The image sensor 100 may be a charge-coupled device (CCD) or a complementary metal-oxide-semiconductor (CMOS), and the zoom lens 101 can be composed of a plurality of lens groups. However, the above-mentioned design for the image sensor 100 and the zoom lens 101 of the first embodiment is merely an example and is not meant to limit the instant disclosure.

Moreover, the auxiliary lighting unit 2 includes at least one auxiliary lighting device 20 having the ability to adjust the divergence angle, and the auxiliary lighting device 20 includes at least one light-emitting element 200 for generating light beams L1, at least one electrically-controlled zoom lens module 201 (such as a single zoom lens or a zoom lens group having a plurality of zoom lens) adjacent and corresponding to the light-emitting element 200, and a second external casing 202 for concurrently receiving the light-emitting element 200 and the electrically-controlled zoom lens module 201. In addition, the light beams L1 generated by the light-emitting element 200 can pass through the electrically-controlled zoom lens module 201 to form a projection light source L2 that can be accurately projected onto the body M for illuminating the body M, and the electrically-controlled zoom lens module 201 has a second variable focus. For example, the light-emitting element 200 may be a light-emitting diode (LED) or a laser diode for generating an infrared source. The electrically-controlled zoom lens module 201 may be a liquid lens 2010 having a variable lens curvature or an adjustable diopter, and the liquid lens 2010 includes two corresponding voltage input electrodes (not shown). However, the above-mentioned design for the light-emitting element 200 and the electrically-controlled zoom lens module 201 of the first embodiment is merely an example and is not meant to limit the instant disclosure.

Furthermore, the control unit 3 includes a voltage controlling module 30 electrically connected between the image-capturing module 10 and the auxiliary lighting device 20, and the two corresponding voltage input electrodes (not shown) of the liquid lens 2010 are electrically connected to the positive electrode (not shown) and the negative electrode (not shown) of the voltage controlling module 30, respectively. In addition, the casing unit 4 includes an external casing 40 for concurrently receiving the image-capturing unit 1, the auxiliary lighting unit 2 and the control unit 3, thus the image-capturing unit 1, the auxiliary lighting unit 2 and the control unit 3 can be concurrently assembled in (or integrated into) the same external casing 40 to form an integral single device. Of course, the external casing 40 can be omitted from the image-capturing system Z of the first embodiment, thus the image-capturing unit 1 and the auxiliary lighting unit 2 can be used as two single devices, and the voltage controlling module 30 of the control unit 3 can be selectively disposed or assembled inside one of the first external casing 102 and the second external casing 202. Alternatively, the voltage controlling module 30 of the control unit 3 can be disposed outside the first external casing 102 and the second external casing 202. However, the above-mentioned design for the voltage controlling module 30 of the first embodiment is merely an example and is not meant to limit the instant disclosure.

More precisely, referring to FIG. 1 to FIG. 4, when the variable object distance (D1, D2) between the body M and the image-capturing module 10 is adjusted or changed (e.g., someone is moved to change the variable object distance from D1 (as shown in FIG. 1) to D2 (as shown in FIG. 2), or someone is moved to change the variable object distance from D2 (as shown in FIG. 2) to D1 (as shown in FIG. 1)), the first variable focus of the zoom lens 101 can be adjusted or changed according to the adjustment or the change of the variable object distance (D1, D2) to generate an object movement signal (S1, S2) that can be transmitted to the voltage controlling module 30. Next, the voltage controlling module 30 can provide a predetermined voltage value (V1, V2) for the electrically-controlled zoom lens module 201 according to the object movement signal (S1, S2) generated by the adjustment or change of the first variable focus of the zoom lens 101. In other words, the predetermined voltage value (V1, V2) provided by the voltage controlling module 30 can be transmitted to the liquid lens 2010 through the two corresponding voltage input electrodes (not shown), thus the variable lens curvature of the liquid lens 2010 can be adjusted according to the predetermined voltage value (V1, V2) that is provided by the voltage controlling module 30. Hence, the divergence angle (θ1, θ2) of the projection light source L2 generated by the auxiliary lighting device 20 can be adjusted according to the adjustment of the variable lens curvature of the liquid lens 2010.

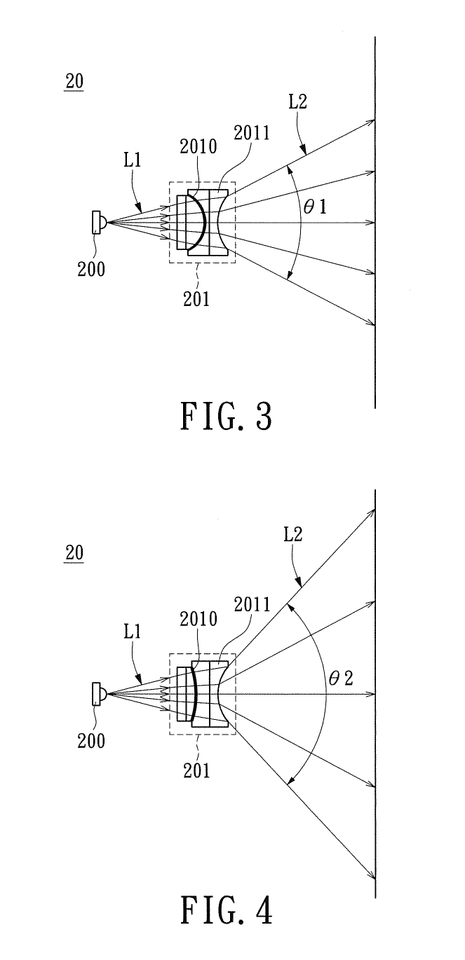

For example, referring to FIG. 1 and FIG. 3, first, when the image-capturing system Z is used indoors (i.e., the near field state), the first variable focus of the zoom lens 101 can be adjusted according to the adjustment of the variable object distance D1 between the body M and the image-capturing module 10 for generating an object movement signal S1 to transmitting to the voltage controlling module 30. Next, the voltage controlling module 30 can provide a predetermined voltage value V1 for the electrically-controlled zoom lens module 201 according to the object movement signal S1 generated by the adjustment of the first variable focus of the zoom lens 101. Then, the variable lens curvature of the liquid lens 2010 can be adjusted according to the predetermined voltage value V1 that is provided by the voltage controlling module 30. Therefore, referring to FIG. 3, the light beams L1 generated by the light-emitting element 200 can be changed into the projection light source L2 having a large divergence angle θ1 according to the change of the variable lens curvature of the liquid lens 2010. In other words, the light beams L1 generated by the light-emitting element 200 can sequentially pass through the liquid lens 2010 and an astigmatic lens 2011 to form the projection light source L2 having a large divergence angle θ1, where the astigmatic lens 2011 may be a negative DLL lens adjacent and corresponding to the liquid lens 2010 and disposed in front of the liquid lens 2010.

For another example, referring to FIG. 2 and FIG. 4, first, when the image-capturing system Z is used indoors, the first variable focus of the zoom lens 101 can be adjusted according to the adjustment of the variable object distance D2 between the body M and the image-capturing module 10 for generating an object movement signal S2 to transmitting to the voltage controlling module 30. Next, the voltage controlling module 30 can provide a predetermined voltage value V2 for the electrically-controlled zoom lens module 201 according to the object movement signal S2 generated by the adjustment of the first variable focus of the zoom lens 101. Then, the variable lens curvature of the liquid lens 2010 can be adjusted according to the predetermined voltage value V2 that is provided by the voltage controlling module 30. Therefore, referring to FIG. 4, the light beams L1 generated by the light-emitting element 200 can be changed into the projection light source L2 having a large divergence angle θ2 according to the change of the variable lens curvature of the liquid lens 2010. In other words, the light beams L1 generated by the light-emitting element 200 can sequentially pass through the liquid lens 2010 and an astigmatic lens 2011 to form the projection light source L2 having a large divergence angle θ2, where the astigmatic lens 2011 may be a negative DLL lens adjacent and corresponding to the liquid lens 2010 and disposed in front of the liquid lens 2010.

In other words, the first variable focus of the zoom lens 101 can be adjusted according to a variable object distance (D1, D2) between the body M and the image-capturing module 10. The voltage controlling module 30 can provide a predetermined voltage value or a predetermined voltage signal (V1, V2) for the electrically-controlled zoom lens module 201 according to the adjustment of the first variable focus of the zoom lens 101. The second variable focus of the electrically-controlled zoom lens module 201 can be adjusted according the predetermined voltage value (V1, V2) that is provided by the voltage controlling module 30, and the divergence angle (θ1, θ2) of the projection light source L2 can be adjusted according to the adjustment of the second variable focus of the electrically-controlled zoom lens module 201. Hence, no matter how the variable object distance (D1, D2) between the body M and the image-capturing module 10 is adjusted or changed, the light beams L1 generated by the light-emitting element 200 can pass through the electrically-controlled zoom lens module 201 to form a projection light source L2 that can be accurately projected onto the body M for illuminating the body M. Hence, the over or under exposure (i.e., too bright or too dark) of the images does not occur in the instant disclosure, thus the definition and the quality of the images of the body M captured by the image-capturing system Z of the instant disclosure can be increased.

### Second Embodiment

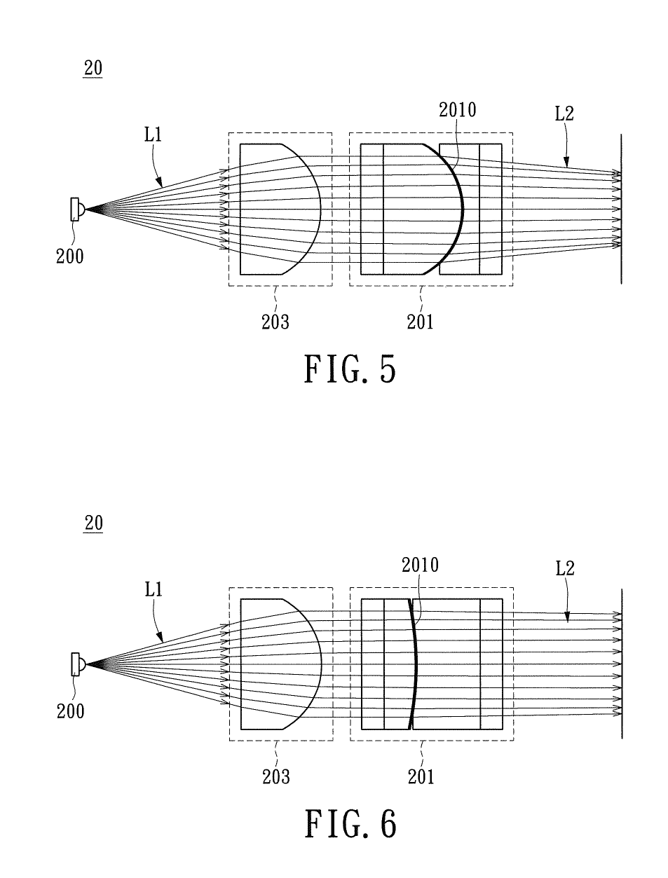

Referring to FIG. 5 and FIG. 6, where the second embodiment of the instant disclosure provides an image-capturing system Z having the ability to adjust the divergence angle. Comparing FIG. 5 with FIG. 3, and comparing FIG. 6 and FIG. 4, the difference between the second embodiment and the first embodiment is as follows: in the second embodiment, the auxiliary lighting device 20 includes at least one light-emitting element 200 for generating light beams L1, at least one electrically-controlled zoom lens module 201, and at least one condensing lens 203 disposed between the light-emitting element 200 and the electrically-controlled zoom lens module 201. In addition, the light beams L1 generated by the light-emitting element 200 can sequentially pass through the condensing lens 203 and the electrically-controlled zoom lens module 201 to form a projection light source L 2 that can be projected onto the body M. It's worth mentioning that the condensing lens 203 is added to place between the light-emitting element 200 and the electrically-controlled zoom lens module 201, thus the light-projecting distance of the projection light source L2 generated by the image-capturing system Z can be increased through the condensing lens 203, and the light-projecting distance of the projection light source L2 generated by the image-capturing system Z can be adjusted according to the second variable focus of the electrically-controlled zoom lens module 201. Hence, the image-capturing system Z of the second embodiment is can be used outdoors (i.e., the far field state).

For example, referring to FIG. 1 and FIG. 5, first, when the image-capturing system Z is used outdoors, the first variable focus of the zoom lens 101 can be adjusted according to the adjustment of the variable object distance D1 between the body M and the image-capturing module 10 for generating an object movement signal S1 to transmitting to the voltage controlling module 30. Next, the voltage controlling module 30 can provide a predetermined voltage value V1 for the electrically-controlled zoom lens module 201 according to the object movement signal S1 generated by the adjustment of the first variable focus of the zoom lens 101. Then, the variable lens curvature of the liquid lens 2010 can be adjusted according to the predetermined voltage value V1 that is provided by the voltage controlling module 30. Therefore, referring to FIG. 5, the light beams L1 generated by the light-emitting element 200 can be changed into the projection light source L2 having a small divergence angle according to the change of the variable lens curvature of the liquid lens 2010. In other words, the light beams L1 generated by the light-emitting element 200 can sequentially pass through the condensing lens 203 and the liquid lens 2010 to form the projection light source L2 having a small divergence angle, and the light-projecting distance of the projection light source L2 can be increased.

For another example, referring to FIG. 2 and FIG. 6, first, when the image-capturing system Z is used outdoors, the first variable focus of the zoom lens 101 can be adjusted according to the adjustment of the variable object distance D2 between the body M and the image-capturing module 10 for generating an object movement signal S2 to transmitting to the voltage controlling module 30. Next, the voltage controlling module 30 can provide a predetermined voltage value V2 for the electrically-controlled zoom lens module 201 according to the object movement signal S2 generated by the adjustment of the first variable focus of the zoom lens 101. Then, the variable lens curvature of the liquid lens 2010 can be adjusted according to the predetermined voltage value V2 that is provided by the voltage controlling module 30. Therefore, referring to FIG. 6, the light beams L1 generated by the light-emitting element 200 can be changed into the projection light source L2 having a small divergence angle according to the change of the variable lens curvature of the liquid lens 2010. In other words, the light beams L1 generated by the light-emitting element 200 can sequentially pass through the condensing lens 203 and the liquid lens 2010 to form the projection light source L2 having a small divergence angle, and the light-projecting distance of the projection light source L2 can be increased.

Hence, no matter how the variable object distance (D1, D2) between the body M and the image-capturing module 10 is adjusted or changed, the light beams L1 generated by the light-emitting element 200 can pass through the electrically-controlled zoom lens module 201 to form a projection light source L2 that can be accurately projected onto the body M for illuminating the body M. Hence, the over or under exposure (i.e., too bright or too dark) of the images does not occur in the instant disclosure, thus the definition and the quality of the images of the body M captured by the image-capturing system Z of the instant disclosure can be increased.

Of course, the position of the electrically-controlled zoom lens module 201 can be changed into another position disposed between the light-emitting element 200 and the condensing lens 203. Therefore, the light beams L1 generated by the light-emitting element 200 can sequentially pass through the electrically-controlled zoom lens module 201 and the condensing lens 203 to form a projection light source L2 that can be accurately projected onto the body M for illuminating the body M and the surroundings of the body M.

In conclusion, because the divergence angle (θ1, θ2) of the projection light source L2 can be adjusted according to the adjustment of the second variable focus of the electrically-controlled zoom lens module 201, no matter how the variable object distance (D1, D2) between the body M and the image-capturing module 10 is adjusted or changed, the light beams L1 generated by the light-emitting element 200 can pass through the electrically-controlled zoom lens module 201 to form a projection light source L2 that can be accurately projected onto the body M for illuminating the body M. Hence, the over or under exposure (i.e., too bright or too dark) of the images does not occur in the instant disclosure, thus the definition and the quality of the images of the body M captured by the image-capturing system Z of the instant disclosure can be increased.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An image-capturing system, comprising:
an image-capturing unit including at least one image-capturing module, wherein the at least one image-capturing module includes an image sensor and a zoom lens adjacent and corresponding to the image sensor, the image sensor is used to capture images of at least one body through the zoom lens, and the zoom lens has a first variable focus;
an auxiliary lighting unit including at least one auxiliary lighting device, wherein the at least one auxiliary lighting device includes at least one light-emitting element for generating light beams and at least one electrically-controlled zoom lens module adjacent and corresponding to the at least one light-emitting element, the light beams generated by the at least one light-emitting element pass through the at least one electrically-controlled zoom lens module to form a projection light source that is projected onto the at least one body, and the at least one electrically-controlled zoom lens module has a second variable focus; and
a control unit including a voltage controlling module electrically connected between the at least one image-capturing module and the at least one auxiliary lighting device;
wherein, the first variable focus of the zoom lens is adjusted according to a variable object distance between the at least one body and the at least one image-capturing module, and the voltage controlling module provides a predetermined voltage value for the at least one electrically-controlled zoom lens module according to the adjustment of the first variable focus of the zoom lens, wherein the second variable focus of the at least one electrically-controlled zoom lens module is adjusted according the predetermined voltage value that is provided by the voltage controlling module, and the divergence angle of the projection light source is adjusted according to the adjustment of the second variable focus of the at least one electrically-controlled zoom lens module.

2. The image-capturing system of claim 1, further comprising: a casing unit including an external casing for concurrently receiving the image-capturing unit, the auxiliary lighting unit and the control unit.

3. The image-capturing system of claim 1, wherein the at least one image-capturing module includes a first external casing for concurrently receiving the image sensor and the zoom lens, the at least one auxiliary lighting device has a second external casing for concurrently receiving the at least one light-emitting element and the at least one electrically-controlled zoom lens module, and the voltage controlling module is disposed inside one of the first external casing and the second external casing.

4. The image-capturing system of claim 1, wherein the at least one light-emitting element is a light-emitting diode or a laser diode for generating an infrared source, the at least one electrically-controlled zoom lens module is a liquid lens having a variable lens curvature, and the variable lens curvature of the liquid lens is adjusted according to the predetermined voltage value that is provided by the voltage controlling module.

5. The image-capturing system of claim 4, wherein the at least one auxiliary lighting device includes an astigmatic lens adjacent and corresponding to the liquid lens, and the light beams generated by the at least one light-emitting element sequentially pass through the liquid lens and the astigmatic lens to form the projection light source.

6. An image-capturing system, comprising:
an image-capturing unit including at least one image-capturing module, wherein the at least one image-capturing module includes an image sensor and a zoom lens adjacent and corresponding to the image sensor, the image sensor is used to capture images of at least one body through the zoom lens, and the zoom lens has a first variable focus;
an auxiliary lighting unit including at least one auxiliary lighting device, wherein the at least one auxiliary lighting device includes at least one light-emitting element for generating light beams, at least one electrically-controlled zoom lens module, and at least one condensing lens disposed between the at least one light-emitting element and the at least one electrically-controlled zoom lens module, the light beams generated by the at least one light-emitting element sequentially pass through the at least one condensing lens and the at least one electrically-controlled zoom lens module to form a projection light source that is projected onto the at least one body, and the at least one electrically-controlled zoom lens module has a second variable focus; and
a control unit including a voltage controlling module electrically connected between the at least one image-capturing module and the at least one auxiliary lighting device;
wherein, the first variable focus of the zoom lens is adjusted according to a variable object distance between the at least one body and the at least one image-capturing module, and the voltage controlling module provides a predetermined voltage value for the at least one electrically-controlled zoom lens module according to the adjustment of the first variable focus of the zoom lens, wherein the second variable focus of the at least one electrically-controlled zoom lens module is adjusted according the predetermined voltage value that is provided by the voltage controlling module, and the divergence angle of the projection light source is adjusted according to the adjustment of the second variable focus of the at least one electrically-controlled zoom lens module.

7. The image-capturing system of claim 6, further comprising: a casing unit including an external casing for concurrently receiving the image-capturing unit, the auxiliary lighting unit and the control unit.

8. The image-capturing system of claim 6, wherein the at least one image-capturing module includes a first external casing for concurrently receiving the image sensor and the zoom lens, the at least one auxiliary lighting device has a second external casing for concurrently receiving the at least one light-emitting element, the at least one electrically-controlled zoom lens module and the at least one condensing lens, and the voltage controlling module is disposed inside one of the first external casing and the second external casing.

9. The image-capturing system of claim 6, wherein the at least one light-emitting element is a light-emitting diode or a laser diode for generating an infrared source, the at least one electrically-controlled zoom lens module is a liquid lens having a variable lens curvature, and the variable lens curvature of the liquid lens is adjusted according to the predetermined voltage value that is provided by the voltage controlling module.

10. An image-capturing system, comprising:
an image-capturing unit including at least one image-capturing module, wherein the at least one image-capturing module includes an image sensor and a zoom lens adjacent and corresponding to the image sensor, the image sensor is used to capture images of at least one body through the zoom lens, and the zoom lens has a first variable focus;
an auxiliary lighting unit including at least one auxiliary lighting device, wherein the at least one auxiliary lighting device includes at least one light-emitting element for generating light beams, at least one condensing lens, and at least one electrically-controlled zoom lens module disposed between the at least one light-emitting element and the at least one condensing lens, the light beams generated by the at least one light-emitting element sequentially pass through the at least one electrically-controlled zoom lens module and the at least one condensing lens to form a projection light source that is projected onto the at least one body, and the at least one electrically-controlled zoom lens module has a second variable focus; and
a control unit including a voltage controlling module electrically connected between the at least one image-capturing module and the at least one auxiliary lighting device;
wherein, the first variable focus of the zoom lens is adjusted according to a variable object distance between the at least one body and the at least one image-capturing module, and the voltage controlling module provides a predetermined voltage value for the at least one electrically-controlled zoom lens module according to the adjustment of the first variable focus of the zoom lens, wherein the second variable focus of the at least one electrically-controlled zoom lens module is adjusted according the predetermined voltage value that is provided by the voltage controlling module, and the divergence angle of the projection light source is adjusted according to the adjustment of the second variable focus of the at least one electrically-controlled zoom lens module.
